(19) United States
(12) Patent Application Publication
(10) Pub. No.: US 2013/0265411 A1
(43) Pub. Date: Oct. 10, 2013

(54) SYSTEM AND METHOD FOR INSPECTING SCRAPED SURFACE OF A WORKPIECE

(71) Applicants: Ching-Wei Wu, Taichung City (TW); Ying-Shing Shiao, Changhua City (TW); Chia-Hui Tang, Taichung City (TW); Paul Chang, Taichung City (TW)

(72) Inventors: Ching-Wei Wu, Taichung City (TW); Ying-Shing Shiao, Changhua City (TW); Chia-Hui Tang, Taichung City (TW); Paul Chang, Taichung City (TW)

(73) Assignees: The Department of Electrical Engineering, National Chang-Hua University of Education, Changhua City (TW); Buffalo Machinery Company Limited, Taichung City (TW)

(21) Appl. No.: 13/442,391

(22) Filed: Apr. 9, 2012

(51) Int. Cl. G06K 9/62; H04N 9/04; H04N 7/18

(52) U.S. Cl. 348/93; 348/92; 382/152; 348/E07.085; 348/E09.002

(57) ABSTRACT

A system for inspecting a scraped surface of a workpiece performs steps of: a) capturing an image of the scraped surface to obtain a original image section; b) removing high point regions whose areas are outside of a predetermined area range to obtain a base image; c) processing pixels of the base image using a first imaging mask to generate a judgment image; d) determining whether uniformity of the high point regions in the base image conforms a standard; e) determining whether a number of the high point regions in the base image falls within a predetermined number range; and f) evaluating whether or not a portion of the scraped surface conforms with the standard based on results of determinations made in steps d) and e).

### BACKGROUND OF THE INVENTION

1. Field of the Invention

The invention relates to a system for inspecting a scraped surface, and more particularly to a system and method for automated inspection of a scraped surface of a workpiece.

2. Description of the Related Art

“Scraping technology” refers to a technique for producing a plurality of grooves in a sliding surface of a workpiece by slightly shoveling, peeling, scratching, etc. The workpiece can thereby store lubricant in the grooves, and regions excluding the grooves (which are generally called high point regions) form a contact surface to promote stability of assembly with other components. For the high point regions, requirement of flatness is high, and there must be enough contact area and high points per unit area.

Conventionally, inspection of a scraped surface is conducted by painting a dye on the scraped surface of the workpiece, and rolling the workpiece on a plane back and forth for several times, such that quality control personnel can identify whether or not quantity and area of the dye transferred to the plane conform with a standard.

However, the conventional inspection depends on judgment and experience of a professional craftsman, and the judgment is often based on naked eye. Accordingly, a lot of time and manpower is spent, and the standard may vary among different persons. In this situation, inconsistencies in the standard and poor precision are likely to occur.

### SUMMARY OF THE INVENTION

Therefore, an object of the present invention is to provide a system for performing a method that can raise precision and facilitate inspection of a scraped surface.

According to one aspect of the present invention, a system for inspecting a scraped surface of a workpiece comprises:

a support unit;

an image capturing device mounted to the support unit and operable to capture an image of the scraped surface of the workpiece; and

an inspecting unit electrically coupled to the image capturing device and including

a pre-processing module for obtaining an original image section from the image captured by the image capturing device, the original image section having a size corresponding to an identification region, the pre-processing module being further operable to find high point regions in the original image section, detect respective areas of the high point regions, and remove those high point regions whose areas are outside of a predetermined area range to obtain a base image,

a computing module for processing pixels of the base image using a first imaging mask to generate a judgment image, and

an evaluating module for determining whether uniformity of the high point regions in the base image conforms with a standard based on conformity of pixels of the judgment image with a predetermined criterion, for determining whether a number of the high point regions in the base image falls within a predetermined number range, and for evaluating whether or not a portion of the scraped surface of the workpiece corresponding to the original image section conforms with the standard based on results of determinations made thereby.

Another object of the present invention is to provide a method that can raise precision and facilitate inspection of a scraped surface.

According to another aspect of the present invention, a method for inspecting a scraped surface of a workpiece comprises the following steps of:

a) capturing an image of the scraped surface of the workpiece and obtaining an original image section (f0) therefrom, the original image section having a size corresponding to an identification region;

b) finding high point regions in the original image section, detecting respective areas of the high point regions, and removing those high point regions whose areas are outside of a predetermined area range to obtain a base image;

c) processing pixels of the base image using a first imaging mask to generate a judgment image;

d) determining whether uniformity of the high point regions in the base image conforms with a standard based on conformity of pixels of the judgment image with a predetermined criterion;

e) determining whether a number of the high point regions in the base image falls within a predetermined number range; and

f) evaluating whether or not a portion of the scraped surface of the workpiece corresponding to the original image section conforms with the standard based on results of determinations made in steps d) and e)

### BRIEF DESCRIPTION OF THE DRAWINGS

Other features and advantages of the present invention will become apparent in the following detailed description of the preferred embodiment with reference to the accompanying drawings, of which:

FIG. 1 is a side schematic view showing a preferred embodiment of a system for inspecting a scraped surface of a workpiece according to the present invention;

FIG. 2 is a front schematic view showing the scraped surface of the workpiece;

FIG. 3 is a block diagram of the system of the preferred embodiment;

FIG. 4 is a front schematic view showing a portion of a calibration board of the preferred embodiment;

FIG. 5 is a flow chart showing steps of a method of the preferred embodiment;

FIG. 6 shows (a) an original image section obtained by the preferred embodiment, (b) an image obtained after finding high point regions in the original image section, and (c) a base image obtained by the preferred embodiment; and

FIG. 7 shows (a) a judgment image obtained by the preferred embodiment, (b) an image obtained after processing the judgment image using a second imaging mask, and (c) a qualification image obtained by the preferred embodiment.

### DETAILED DESCRIPTION OF THE PREFERRED EMBODIMENT

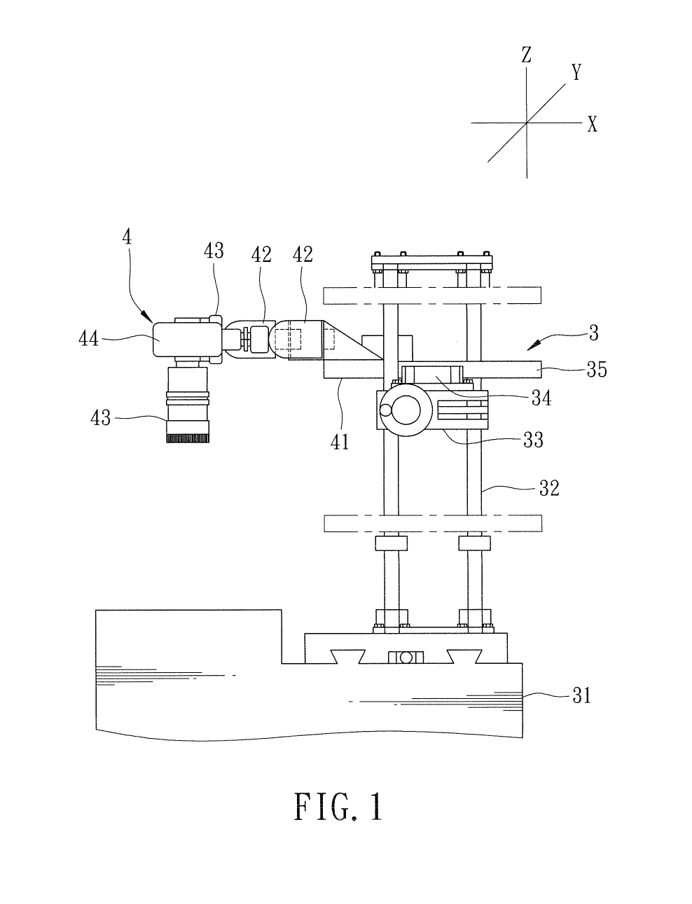

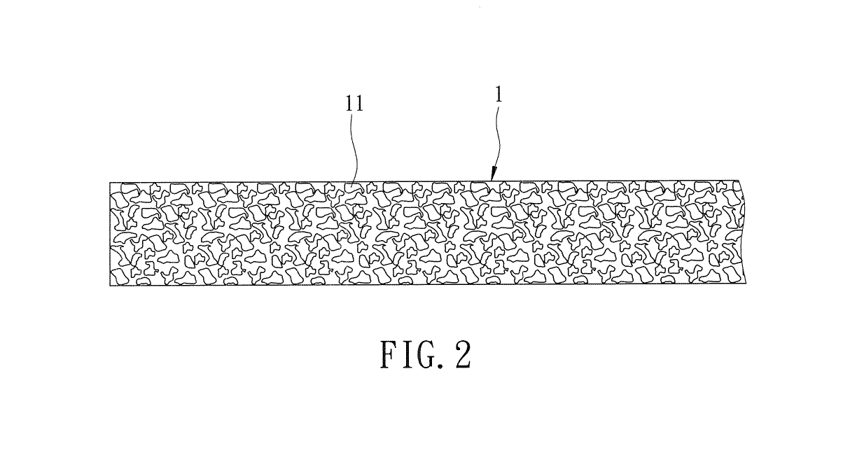

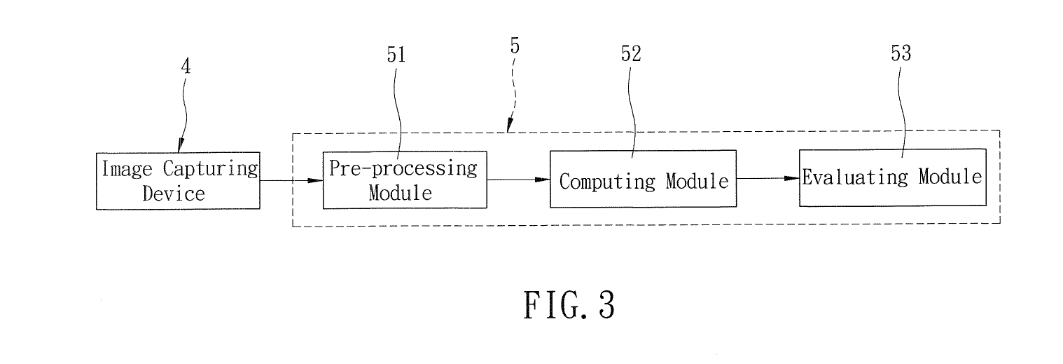

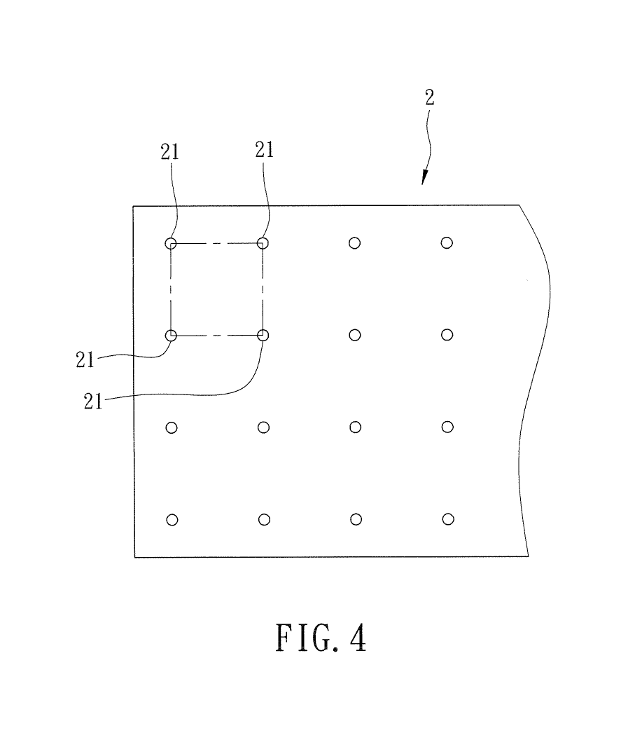

Referring to FIG. 1 to FIG. 4, the preferred embodiment of the system for inspecting a scraped surface is utilized for inspecting a workpiece 1. The workpiece 1 has a plurality of high point regions 11 formed as a result of scraping and on a surface thereof. The system comprises a calibration board 2, a support unit 3, an image capturing device 4, and an inspecting unit 5.

The calibration board 2 is removably disposed on the support unit 3 and has a board surface. The board surface has a plurality of spaced apart color spots 21.

The support unit 3 is used for loading the workpiece 1, and includes a base 31, a supporting frame 32 mounted on the base 31 in a Z-axis direction, a track frame 33 slideable on the supporting frame 32 in the Z-axis direction, a sliding connection member 34 installed on the track frame 33, and a slider member 35 slideable on the sliding connection member 34 in an X-axis direction or a Y-axis direction. The base 31 can be mounted on a fixed object (not shown) if the workpiece 1 is movable in the X-axis direction or in the Y-axis direction, and can be mounted on a movable object (not shown, such as an XY table) if the workpiece 1 is not movable.

The image capturing device 4 includes a positioning frame 41 connected to an end of the slider member 35, two blocks 42 pivoted on the positioning frame 41, and a camera 43 and a lamp component 44 that are rotatably and respectively provided on the blocks 42.

The inspecting unit 5 is electrically coupled to the image capturing device 4 and includes a pre-processing module 51, a computing module 52, and an evaluating module 53.

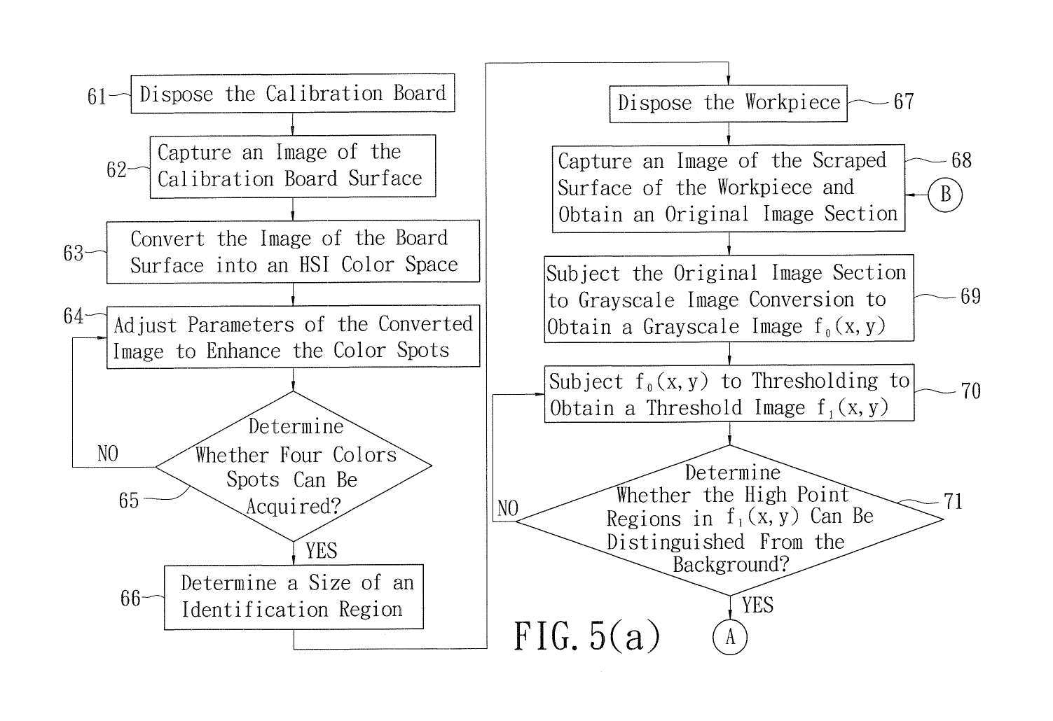

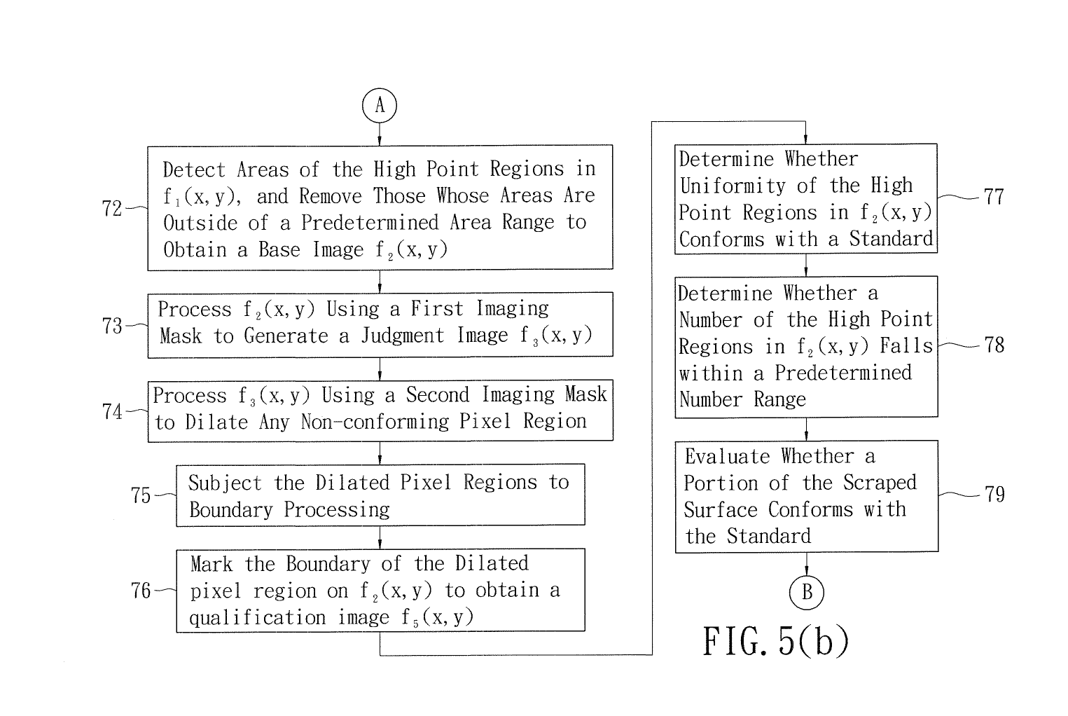

Further referring to FIG. 5, a method for inspecting the scraped surface of the workpiece 1 comprises the following steps.

Step 61: The calibration board 2 is disposed under the camera 43.

Step 62: The camera 43 is operated to capture an image of the board surface of the calibration board 2.

Step 63: The pre-processing module 51 is operated to convert the image of the board surface into a hue saturation intensity (HSI) color space.

Step 64: The pre-processing module 51 is operated to adjust parameters in the image of the board surface converted in step 63, such as hue, saturation, light intensity, etc., for image enhancement of the color spots 21, which have high color saturation.

Step 65: The pre-processing module 51 is operated to determine whether or not four adjacent ones of the color spots 21 in the image of the board surface can be acquired. When the determination is affirmative, the flow goes to step 66. Otherwise, the flow goes back to step 64.

Step 66: The pre-processing module 51 is operated to determine a size of an identification region by determining an area bounded by four adjacent ones of the color spots 21 in the image of the board surface. In this preferred embodiment, the adjacent color spots are spaced apart from each other by 1 inch, so that the size of the identification region is 1 square inch.

It should be noted that a position of a color-mass-center of each color spot 21 can be obtained in the HSI color space. Because the distance between adjacent color spots is known, the position of each color spot 21 can be converted from an image coordinate system to a global coordinate system.

Step 67: The workpiece 1 is disposed under the camera 43.

Step 68: The camera 43 is operated to capture an image of the scraped surface of the workpiece 1 and obtain an original image section therefrom. The original image section has a size corresponding to the identification region. That is, the size of the original image section corresponds to 1 square inch of the scraped surface of the workpiece 1 in this embodiment.

It should be noted that the camera 43 is movable in the Z-axis direction on the support frame 32 through the track frame 33, or in the X-axis direction on the sliding connection member 34 through the slider member 35 prior to capturing an image, so as to adjust a desired viewing area thereof. The camera 43 and the lamp component 44 are rotatable on the blocks 42 for angle adjustment. Reflected light intensity of the workpiece 1 may be adjusted by light compensation, to thereby enhance recognition of the captured image. The support unit 3 and the image capturing device 4 are movable relative to the workpiece 1, such that the camera 43 is operable to capture the image of the whole scraped surface of the workpiece 1 by scanning.

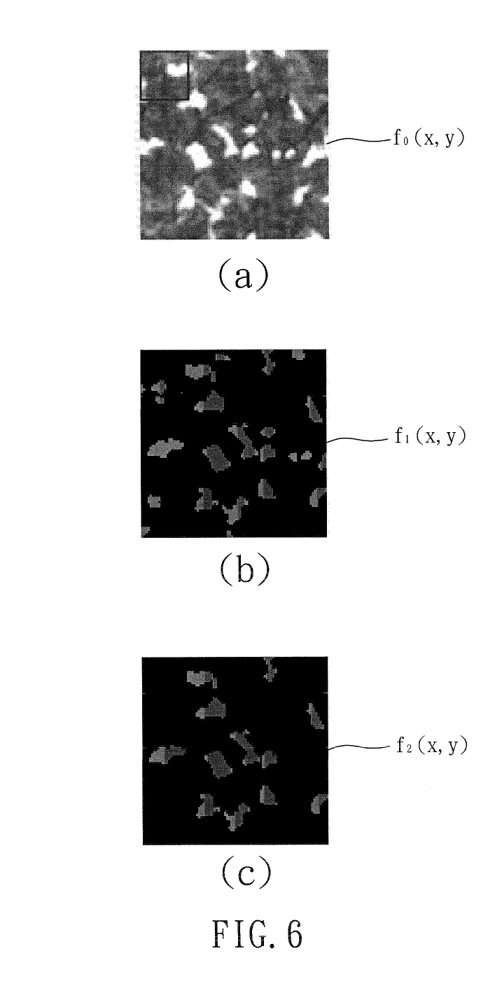

Step 69: The pre-processing module 51 is operated to subject the original image section to grayscale image conversion to obtain a grayscale image f₀(x, y), as shown in FIG. 6(a).

Step 70: The pre-processing module 51 is operated to subject the grayscale image f₀(x, y) to thresholding for image enhancement of high point regions for finding the high point regions 11 in the original image section, thereby obtaining a threshold image f₁(x, y), as shown in FIG. 6(b).

Step 71: The pre-processing module 51 is operated to determine whether or not the high point regions 11 in the threshold image f₁(x, y) can be distinguished from the background of the threshold image f₁(x, y). When the determination is affirmative, the flow goes to step 72. Otherwise, the flow goes back to step 70.

Step 72: The pre-processing module 51 is operated to detect respective areas of the high point regions 11 in the threshold image f₁(x, y), and remove those high point regions whose areas are outside of a predetermined area range to obtain a base image f₂(x, y), as shown in FIG. 6(c). In this embodiment, the threshold image f₁(x, y) is scanned when detecting the respective areas of the high point regions.

It should be noted that, because four corners of the base image f₂(x, y) correspond to the positions of the four adjacent color spots 21 that define the identification region, each pixel of the base image f₂(x, y) can be denoted in a form of the global coordinate system.

In this embodiment, the predetermined area range is between 1/256 and 4/256 of the identification region. That is, anyone high point region 11 whose area is smaller than 1/256 or greater than 4/256 square inch is removed from the threshold image f₁(x, y) to obtain the base image f₂(x, y).

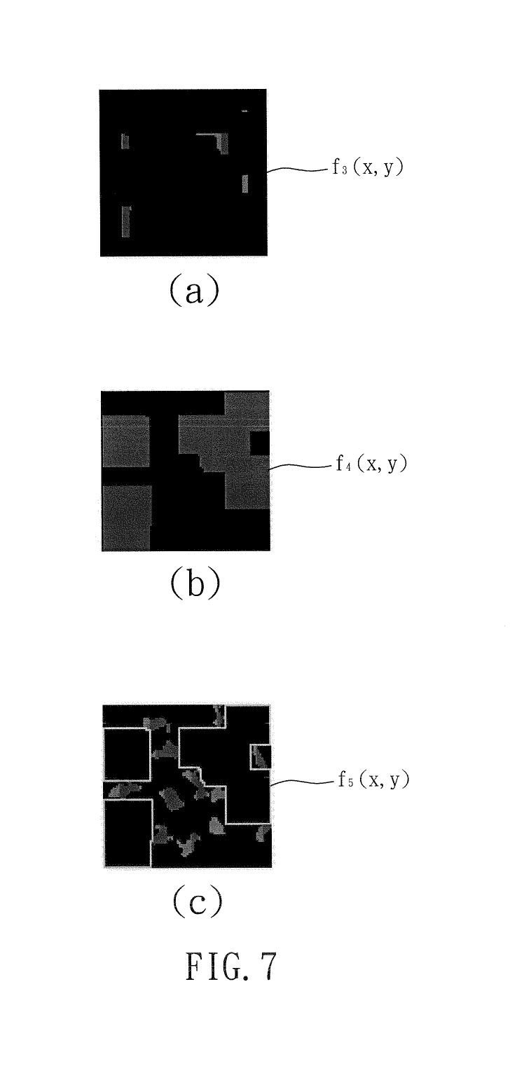

Step 73: The computing module 52 is operated to process pixels of the base image f₂(x, y) using a first imaging mask to generate a judgment image f₃(x, y) pixel by pixel, as shown in FIG. 7(a). The judgment image f₃(x, y) shows pixel regions whose processed results do not conform with a predetermined criterion.

Step 74: The computing module 52 is operated to process the judgment image f₃(x, y) using a second imaging mask to dilate any pixel region constituted by the pixels that do not conform with the predetermined criterion, as shown in FIG. 7(b).

Step 75: The computing module 52 is operated to subject the pixel regions dilated in step 74 to boundary processing.

Step 76: The computing module 52 is operated to mark the boundary of the dilated pixel region processed in step 75 on the base image f₂(x, y) to obtain a qualification image f₅(x, y), as shown in FIG. 7(c).

Step 77: The evaluating module 53 is operated to determine whether or not uniformity of the high point regions 11 in the base image f₂(x, y) conforms with a standard based on conformity of pixels of the judgment image f₃(x, y) with the predetermined criterion. In this embodiment, uniformity of the high point regions 11 is determined to be non-conforming with the standard when any of the pixels of the judgment image f₃(x, y) does not conform with the predetermined criterion.

Step 78: The evaluating module 53 is operated to determine whether a number of the high point regions 11 in the base image f₂(x, y) falls within a predetermined number range. In this embodiment, the predetermined number range is between 16 and 24 per square inch.

Step 79: The evaluating module 53 is operated to evaluate whether or not a portion of the scraped surface of the workpiece 1 corresponding to the original image section conforms with the standard based on results of determinations made in steps 77 and 78. In this embodiment, the portion of the scraped surface of the workpiece 1 corresponding to the original image section is evaluated as conforming with the standard when uniformity of the high point regions 11 is determined to conform with the standard and the number of the high point regions 11 in the base image f₂(x, y) falls within the predetermined number range.

Then, the flow goes back to step 68 to evaluate another portion of the scraped surface of the workpiece 1 until evaluation of the whole scraped surface of the workpiece 1 is finished.

It should be noted that, in this embodiment, processing of the base image f₂(x, y) in step 73 and processing of the judgment image f₂(x, y) in step 74 are conducted using convolution computation processing. In addition, the qualification image f₅(x, y), which is generated through steps 74, 75, and 76, is not used for evaluating the scraped surface, but is used by quality control personnel to identify the regions of the portion of the scraped surface that do not conform with the standard.

The system and method of this invention are able to realize automated inspection of the scraped surface of the workpiece 1. Compared to uncertainty of conventional inspection by personnel, automation raises precision, saves manpower, and shortens the inspection time.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A system for inspecting a scraped surface of a workpiece, comprising:
a support unit;
an image capturing device mounted to said support unit and operable to capture an image of the scraped surface of the workpiece; and
an inspecting unit electrically coupled to said image capturing device and including
a pre-processing module for obtaining an original image section from the image captured by said image capturing device, the original image section having a size corresponding to an identification region, said pre-processing module being further operable to find high point regions in the original image section, detect respective areas of the high point regions, and remove those high point regions whose areas are outside of a predetermined area range to obtain a base image,
a computing module for processing pixels of the base image using a first imaging mask to generate a judgment image, and
an evaluating module for determining whether uniformity of the high point regions in the base image conforms with a standard based on conformity of pixels of the judgment image with a predetermined criterion, for determining whether a number of the high point regions in the base image falls within a predetermined number range, and for evaluating whether or not a portion of the scraped surface of the workpiece corresponding to the original image section conforms with the standard based on results of determinations made thereby.

2. The system as claimed in claim 1, wherein said support unit includes a base, a supporting frame mounted on said base, and a track frame slideable on said supporting frame and connected to said image capturing device.

3. The system as claimed in claim 2, wherein said support unit further includes a sliding connection member installed on said track frame, and a slider member slideable on said sliding connection member and connected to said image capturing device.

4. The system as claimed in claim 3, wherein said image capturing device includes a positioning frame connected to said slider member, and a camera that is rotatably provided on said positioning frame.

5. The system as claimed in claim 4, wherein said image capturing device further includes a lamp component rotatably provided on said positioning frame.

6. The system as claimed in claim 3, wherein said image capturing device is operable to capture the image of the scraped surface of the workpiece by scanning.

7. The system as claimed in claim 1, further comprising:
a calibration board removably disposed on said support unit and having a board surface, the board surface having a plurality of spaced apart color spots;
said image capturing device being operable to capture an image of said board surface of said calibration board;
said pre-processing module being operable to convert the image of the board surface into a hue saturation intensity color space, and to determine the size of the identification region by determining an area bounded by four adjacent ones of said color spots in the image of said board surface.

8. A method for inspecting a scraped surface of a workpiece, comprising the following steps of:
a) capturing an image of the scraped surface of the workpiece and obtaining an original image section therefrom, the original image section having a size corresponding to an identification region;
b) finding high point regions in the original image section, detecting respective areas of the high point regions, and removing those high point regions whose areas are outside of a predetermined area range to obtain a base image;
c) processing pixels of the base image using a first imaging mask to generate a judgment image;
d) determining whether uniformity of the high point regions in the base image conforms with a standard based on conformity of pixels of the judgment image with a predetermined criterion;
e) determining whether a number of the high point regions in the base image falls within a predetermined number range; and
f) evaluating whether or not a portion of the scraped surface of the workpiece corresponding to the original image section conforms with the standard based on results of determinations made in steps d) and e).

9. The method as claimed in claim 8, wherein, in step a), the image of the scraped surface of the workpiece is captured by scanning.

10. The method as claimed in claim 8, further comprising, prior to step a):
capturing an image of a board surface of a calibration board, the board surface having a plurality of spaced apart color spots; and
converting the image of the board surface into a hue saturation intensity color space, and determining the size of the identification region by determining an area bounded by four adjacent ones of the color spots in the image of the board surface.

11. The method as claimed in claim 8, wherein, in step b), the original image section is subjected to grayscale image conversion and thresholding for image enhancement of the high point regions for finding the high point regions in the original image section,

12. The method as claimed in claim 8, further comprising the steps of:
processing the judgment image using a second imaging mask to dilate any pixel region constituted by the pixels that do not conform with the predetermined criterion; and
marking the dilated pixel region on the base image to obtain a qualification image.

13. The method as claimed in claim 12, wherein processing of the base image and processing of the judgment image are conducted using convolution computation processing.

14. The method as claimed in claim 12, wherein the dilated pixel region is subjected to boundary processing prior to marking on the base image to obtain the qualification image.

15. The method as claimed in claim 8, wherein, in step b), the respective areas of the high point regions are detected by scanning.

16. The method as claimed in claim 8, wherein, in step c), processing of the pixels of the base image using the first imaging mask is conducted pixel by pixel to generate the judgment image.

17. The method as claimed in claim 8, wherein, in step d), uniformity of the high point regions is determined to be non-conforming with the standard when any of the pixels of the judgment image does not conform with the predetermined criterion.

18. The method as claimed in claim 8, wherein, in step e), the predetermined number range is between 16 and 24 per square inch.

19. The method as claimed in claim 8, wherein, in step f), the portion of the scraped surface of the workpiece corresponding to the original image section is evaluated as conforming with the standard when uniformity of the high point regions is determined to conform with the standard and the number of the high point regions in the base image falls within the predetermined number range.

20. The method as claimed in claim 8, wherein, in step b), the predetermined area range is between 1/256 and 4/256 of the identification region.
